(19) United States
(12) Patent Application Publication
(10) Pub. No.: US 2014/0231728 A1
(43) Pub. Date: Aug. 21, 2014

(54) ELECTROPHORETIC FLUID

(71) Applicant: SIPIX IMAGING, INC., Fremont, CA (US)

(72) Inventors: Hui DU, Milpitas, CA (US); Ming Wang, Fremont, CA (US); Yu Li, Fremont, CA (US); Roman Ivanov, Milpitas, CA (US); HongMei Zang, Fremont, CA (US)

(73) Assignee: SIPIX IMAGING, INC., Fremont, CA (US)

(21) Appl. No.: 14/179,458

(22) Filed: Feb. 12, 2014

Related U.S. Application Data
(60) Provisional application No. 61/765,550, filed on Feb. 15, 2013.

(51) Int. Cl. G02F 1/167

(52) U.S. Cl. CPC G02F 1/167
USPC 252/583

(57) ABSTRACT

The present invention is directed to an electrophoretic fluid comprising transparent particles, as an additive. The presence of the transparent particles in the fluid provides improved display performance.

This application claims priority to U.S. Provisional Application No. 61/765,550 filed Feb. 15, 2013; the content of which is incorporated herein by reference in its entirety.

### FIELD OF THE INVENTION

The present invention is directed to transparent particles suitable as an additive for an electrophoretic fluid and an electrophoretic fluid comprising such transparent particles.

### BACKGROUND OF THE INVENTION

An electrophoretic display (EPD) is a non-emissive device based on the electrophoresis phenomenon influencing charged pigment particles dispersed in a dielectric solvent. An EPD typically comprises a pair of spaced-apart plate-like electrodes. At least one of the electrode plates, typically on the viewing side, is transparent. An electrophoretic fluid composed of a dielectric solvent with charged pigment particles dispersed therein is enclosed between the two electrode plates.

An electrophoretic fluid may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate may be either the color of the solvent or the color of the pigment particles. Reversal of plate polarity will cause the particles to migrate back to the opposite plate, thereby reversing the color.

Alternatively, an electrophoretic fluid may have two types of pigment particles of contrasting colors and carrying opposite charges, and the two types of pigment particles are dispersed in a clear solvent or solvent mixture. In this case, when a voltage difference is imposed between the two electrode plates, the two types of pigment particles would move to the opposite ends (top or bottom) in a display cell. Thus one of the colors of the two types of the pigment particles would be seen at the viewing side of the display cell.

For all types of the electrophoretic displays, the fluid contained within the individual display cells of the display is undoubtedly one of the most crucial parts of the device. The composition of the fluid determines, to a large extent, the lifetime, contrast ratio, switching rate and bistability of the device.

In an ideal fluid, the charged pigment particles remain separate and do not agglomerate or stick to each other or to the electrodes, under all operating conditions. In addition, all components in the fluid must be chemically stable and compatible with other materials present in an electrophoretic display.

### SUMMARY OF THE INVENTION

The present invention is directed to an electrophoretic fluid which comprises charged non-transparent particles and transparent particles all of which are dispersed in a solvent, wherein the refractive index of the transparent particles is substantially the same as that of the solvent.

In one embodiment, the refractive index is lower than 1.5.

In one embodiment, the transparent particles take up less than 20% by volume of the fluid. In another embodiment, the transparent particles take up less than 10% by volume of the fluid.

In one embodiment, the transparent particles are formed from an organic material. In another embodiment, the transparent particles are formed from an inorganic material.

In one embodiment, the transparent particles are formed from a monomer or oligomer selected from the group consisting of acrylate or methacrylate, siloxane modified acrylate or methacrylate and halogenated acrylate or methacrylate.

In one embodiment, the transparent particles have an average size of less than 0.5 μm, or less than 0.3 μm or less than 0.1 μm.

In one embodiment, the non-transparent charged pigment particles are white particles which carry a positive or negative charge polarity. In another embodiment, the non-transparent charged pigment particles are black and white particles carrying opposite charge polarities.

In one embodiment, the solvent is a hydrocarbon solvent. In another embodiment, the solvent is halogenated or fluorinated.

In one embodiment, the transparent particles are non-charged. In another embodiment, the transparent particles are charged. In a further embodiment, the transparent particles carry a charge the polarity of which is the same as that carried by one type of the non-transparent charged pigment particles, but have a different level of mobility than that of the non-transparent charged pigment particles.

In one embodiment, the fluid further comprises a charge control agent.

### DETAILED DESCRIPTION OF THE INVENTION

The present invention is directed to transparent particles useful as an additive in an electrophoretic fluid.

In one embodiment, the transparent particles have a refractive index preferably lower than 1.5, more preferably to be about 1.4. The refractive index of the transparent particles is substantially the same as the refractive index of the solvent in the electrophoretic fluid, so that the transparent particles do not scatter light and are transparent or close to be transparent in the fluid. The term “substantially the same” refers to the difference between the two refractive indices not exceeding 10%.

The amount of the transparent particles in an electrophoretic fluid is preferably less than 20% and more preferably less than 10%, by volume.

The transparent particles may be formed of an organic material, such as a polymeric material. In this case, the starting monomers or oligomers may be acrylate or methacrylate, siloxane modified acrylate or methacrylate, halogenated acrylate or methacrylate or monomers that can form a polyurethane.

The monomers or oligomers undergo emulsion polymerization, seed polymerization, soap-free polymerization, dispersion polymerization, suspension polymerization, phase inversion polymerization or the like, to form the transparent particles.

Examples of the resulting material from polymerization may include, but are not limited to, poly(methyl methacrylate), poly(butyl acrylate), poly(perfluorobutylethyl acrylate), poly(perfluorohexyl ethyl methacrylate) and poly(methacrylate terminated dimethylsiloxanes).

In the polymerization process, a dispersant is preferably present. The dispersant allows the transparent particles to be formed in a desired average size range (e.g., less than 0.5 μm, preferably less than 0.3 μm and more preferably less than 0.1 μm). The dispersant may also cause formation of a layer physically or chemically bonded to the surface of the transparent particles to prevent the particles from agglomeration in the electrophoretic fluid.

The term “dispersant”, in the context of the present application, broadly includes any materials which promote dispersion or to maintain dispersed particles in a suspension state. Dispersants particularly suitable for the purpose of the present invention preferably have a long chain (of at least eight carbon atoms or Si—O repeating units) and therefore they can stabilize the transparent particles in a solvent in the polymerization process or in the final fluid. Such dispersants may be an acrylate-terminated or vinyl-terminated macromolecule. They are suitable because the acrylate or vinyl group can co-polymerize with the monomers or oligomers in the polymerization process.

One specific example of the dispersant is acrylate terminated polysiloxane (Gelest, MCR-M17, MCR-M22), as shown below:

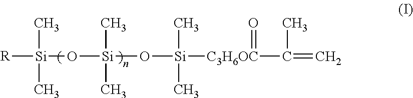

The molecular weight of the polysiloxane of Formula (I) is higher than 5000.

Another specific example is polyethylene macromonomer, as shown below:

CH₃—[—CH₂—]ₙ—CH₂O—C(═O)—C(CH₃)═CH₂ (II)

The backbone of the macromonomer (II) may be a polyethylene chain and n may be 30-200. The synthesis of this type of macromonomers may be found in Seigou Kawaguchi et al, Designed Monomers and Polymers, 2000, 3, 263.

If the fluid system is fluorinated or halogenated, the dispersants are then preferably also fluorinated or halogenated.

In another embodiment, the transparent particles can be made from an inorganic material, such as silica, with a refractive index lower than 1.5.

The transparent particles of the present invention may be added to an electrophoretic fluid comprising one type, two types or multiple types of pigment particles dispersed in a solvent or solvent mixture, as an additive. In a one particle system, one type of charged pigment particles is dispersed in a solvent or solvent mixture. In a two particle system, two types of pigment particles of contrasting colors and carrying opposite charge polarities are dispersed in a solvent or solvent mixture. In a multiple particle system, there may be more than two types of pigment particles of different colors and the multiple types of particles may have different charge polarities, different levels of charge intensity or different levels of mobility. The charged pigment particles referred to in the one particle system, the two particle system or the multiple particle system, are non-transparent particles.

The solvent in the electrophoretic fluid may be a hydrocarbon solvent, such as dodecane, tetradecane, the aliphatic hydrocarbons in the Isopar® series (Exxon, Houston, Tex.) or the like. The solvent can also be a mixture of a hydrocarbon and a halogenated carbon or silicone oil base material.

The transparent particles are useful as an additive in an electrophoretic fluid. For example, when the transparent particles are non-charged, they can reduce agglomeration between the charged particles, thus also reducing the ghosting phenomenon during driving; but they do not have a negative impact on the color exhibition. When the transparent particles are non-charged, they show no mobility under an electric field.

If the transparent particles have the same level of charge intensity as, or a higher level of charge intensity than, the charge intensity of the charged non-transparent particles, they can compete with the non-transparent particles to prevent the non-transparent particles from sticking to a dielectric layer.

When the transparent particles are charged, they may carry a charge the polarity of which is the same as that carried by one type of the charged pigment particles, and in this case, the transparent particles have a different level of mobility than that of the other particles in the fluid.

An electrophoretic fluid which comprises transparent particles of the present invention may further comprise a charge control agent, which may be polymeric, non-polymeric, ionic or non-ionic. The charge control agent may be an ionic surfactant, such as sodium dodecylbenzenesulfonate, metal soap, polybutene succinimide, maleic anhydride copolymers, vinylpyridine copolymers, vinylpyrrolidone copolymer, (meth)acrylic acid copolymers or N,N-dimethylaminoethyl (meth)acrylate copolymers), Alcolec LV30 (soy lecithin), Petrostep B100 (petroleum sulfonate) or B70 (barium sulfonate), Solsperse 17000 (active polymeric dispersant), Solsperse 9000 (active polymeric dispersant), OLOA 11000 (succinimide ashless dispersant), OLOA 1200 (polyisobutylene succinimides), Unithox 750 (ethoxylates), Petronate L (sodium sulfonate), Disper BYK 101, 2095, 185, 116, 9077 & 220 and ANTI-TERRA series.

### EXAMPLE

In a three-neck reaction flask, 200 ml of solvent (silicone oil, DMS-T01 from Gelest) is added, followed by adding 32 g of a stabilizer (MCR-M22, Gelest) to the solvent. To the resulting mixture, 16 g of a monomer (methyl methacrylate) is added. Nitrogen is then purged into the flask and the temperature is increased to 65° C. while stirring. An initiator, LPO (lauryl peroxide), in the amount of about 0.4 g, is added into the flask. The reaction continues for 15 hours, after which polymer particles are formed. The polymer particles can be separated from the liquid through centrifugation to remove un-reacted species, and re-dispersed into a solvent (Isopar G).

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. An electrophoretic fluid comprising charged non-transparent particles and transparent particles all of which are dispersed in a solvent, wherein the refractive index of the transparent particles is substantially the same as that of the solvent.

2. The fluid of claim 1, wherein the refractive index is lower than 1.5.

3. The fluid of claim 1, wherein the transparent particles take up less than 20% by volume of the fluid.

4. The fluid of claim 1, wherein the transparent particles take up less than 10% by volume of the fluid.

5. The fluid of claim 1, wherein the transparent particles are formed from an organic material.

6. The fluid of claim 1, wherein the transparent particles are formed from an inorganic material.

7. The fluid of claim 5, wherein the transparent particles are formed from a monomer or oligomer selected from the group consisting of acrylate or methacrylate, siloxane modified acrylate or methacrylate, and halogenated acrylate or methacrylate.

8. The fluid of claim 1, wherein the transparent particles have an average size of less than 0.5 μm.

9. The fluid of claim 1, wherein the transparent particles have an average size of less than 0.3 μm.

10. The fluid of claim 1, wherein the transparent particles have an average size of less than 0.1 μm.

11. The fluid of claim 1, wherein the non-transparent charged pigment particles are white particles which carry a positive or negative charge polarity.

12. The fluid of claim 1, wherein the non-transparent charged pigment particles are black and white particles carrying opposite charge polarities.

13. The fluid of claim 1, wherein the solvent is a hydrocarbon solvent.

14. The fluid of claim 1, wherein the solvent is halogenated or fluorinated.

15. The fluid of claim 1, wherein the transparent particles are non-charged.

16. The fluid of claim 1, wherein the transparent particles are charged.

17. The fluid of claim 16, wherein the transparent particles carry a charge the polarity of which is the same as that carried by one type of the non-transparent charged pigment particles, but have a different level of mobility than that of the non-transparent charged pigment particles.

18. The fluid of claim 1, further comprising a charge control agent.
